(19) United States
(12) Patent Application Publication
(10) Pub. No.: US 2005/0058893 A1
(43) Pub. Date: Mar. 17, 2005

(54) Remote battery pack power supply for a hand held tool

(76) Inventor: Brian J. O'Neal, Grants Pass, OR (US)

Correspondence Address: James D. Givnan, Jr., 8175 S. W. Ernst Road, Portland, OR, 97225, US

(21) Appl. No.: 10/662,239

(22) Filed: Sep. 16, 2003

(51) Int. Cl. H01M 2/10

(52) U.S. Cl. 429/123; 429/96; 429/98

(57) ABSTRACT

A hand-held power tool is powered by a remote battery pack in place on a workman's tool belt or other support. A light weight electrical connector, in inserted engagement with the tool, is served by an electrical cord in circuit with the remote battery pack. For tool use where arms fatigue is of no concern, the battery pack may alternatively be plugged into the power tool in a conventional manner.

### BACKGROUND OF THE INVENTION

The present invention pertains generally to that class of power tools that are hand held and particularly those powered by a battery pack.

To facilitate convenient use on the job power tools are frequently powered by a battery pack thus dispensing with a power outlet and cord. A disadvantage to the powering of a hand held power tool with a battery pack is the matter of significant weight added to the tool by the battery pack. In certain do-it-yourself tasks the weight is of little consequence as battery pack weighs in the range of 16 ounces to 24 ounces. A problem arises when the job at hand requires the tool to be used in overhead fashion as may be the case with electricians and carpenters. An additional drawback to battery pack powered hand held tools is that a back-up battery pack must be readily available for substitution in the tool in the event of the battery pack being used is exhausted. Work being done on an elevated structure and utilizing ladders or scaffolding results in time lost from the task at hand in acquiring and installing a replacement battery pack. After lengthy periods of use a battery pack equipped hand held tool results in substantial reduction in worker efficiency by reason of muscle fatigue. A hand held power drill or screwdriver with battery pack may weigh approximately three pounds.

### SUMMARY OF THE PRESENT INVENTION

The present invention is embodied in a power system for a hand held power tool which dispenses with the encumbrance of an attached battery pack.

An electrical connector is provided, including a power plug for insertion into the electrical socket of the tool. Latch means retains the connector in place, all achieved without the addition of significant weight to the hand held tool. A power source for the tool includes a remote battery pack in place on a ladder, scaffolding, etc., or carried in place on the worker's attire.

Important objectives of the present invention include the provision of a power source for a hand held power tool dispensing with the weight of a tool attached battery pack; the provision of a power source for a hand held power tool wherein a battery pack is supported at a remote point on the worker or other support adjacent the work site; the provision of a power system for a hand held power tool wherein a battery pack is provided with attachment means for engagement with a component of the user's attire such as a tool belt; the provision of a power system for a hand held tool wherein an electrical connector is served by a battery pack located remotely from the hand held tool, thereby avoiding the addition of battery pack weight to the hand tool; the provision of a dual use battery pack for connection to a power tool via a cord or by direct engagement with the tool.

### BRIEF DESCRIPTION OF THE DRAWINGS

In the accompanying drawings:

FIG. 1 shows a hand tool in use and equipped with the present power supply system;

FIG. 2 is an elevational view of a hand held tool with a battery pack supported on a belt;

FIG. 3 is a view taken downwardly along line 3-3 of FIG. 2;

FIG. 4 is a vertical sectional view taken along line 4-4 of FIG. 2; and

FIG. 5 is an elevational view of a battery pack charger with a battery pack in place.

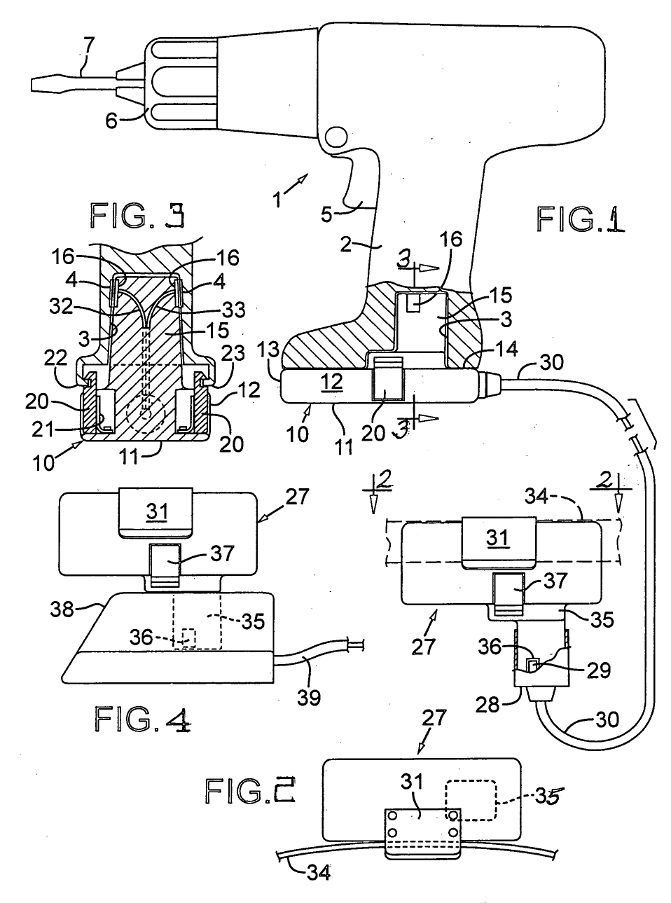

### DETAILED DESCRIPTION OF THE PREFERRED EMBODIMENTS

With continuing attention to the drawings wherein applied reference numerals indicate parts similarly hereinafter identified in the following description, the reference numeral 1 indicates generally a hand held power tool which may be used for powering a drill or a screwdriver bit. Such tools are commonly used by workers performing various tasks including those requiring positioning and maintaining the hand held tool over the user's head. A tool hand grip is a 2 and defines a socket 3 having electrical contacts 4 (FIG. 4) therein. Other tool components include a trigger 5 and a chuck 6 for a tool 7.

An electrical connector of the present system is indicated generally at 10 and includes a base 11 having side walls as at 12 and end walls as at 13. A top wall 14 serves to support a plug member 15 on which are oppositely disposed, electrical contacts as at 16.

With attention to FIG. 4, retention means at 20 include a pair of spring biased latches with leaf springs 21 biasing the latches 20 transversely of the base in an outward direction whereat the latch upper ends, grooved at 22, seat on inwardly directed flanges 23 integral with grip 2 of the power tool. Plug 15 of the connector is in a sliding fit with the walls of receptacle 3 of the tool with the plug serving to orientate the contact 16 thereon and specifically the latches 20 to seat against tool flanges 23 during coupling of the connector to the tool. The latches 20 are operated by fingertip pressure applied in a simultaneous manner to inwardly offset the latch grooved upper ends during connector detachment from the power tool.

A battery pack at 27 has a power plug 35 adapted to receive a socket 28 on an electrical cord 30 with a DC current flow to contacts 16 on connector plug 15. Plug carried leads 32-33 (FIG. 4) are each in circuit with a conductor in cord 30 which is several feet in length and terminates oppositely at a socket 28, for convenient cord transfer to a fresh battery pack. Socket 28 includes a pair of contacts as at 29.

A clip 31 carried by battery pack 27 facilitates battery pack attachment to a worker's tool belt 34. Power plug at 35 with contacts as at 36 cooperates with socket contacts 29 or alternatively to permit conventional attachment of battery pack 27 to the power tool when the task at hand does not incur overhead or fatiguing work. In such an instance connector 10 would of course be detached from the power tool and power plug 35 of battery pack 27 inserted directly into the hand held power tool. Battery pack 27 includes latches 37 of the type above described and each having a groove for seated engagement with the flanges at 23 on tool grip 2 when the battery pack is alternatively utilized with power plug 35 in place in socket 3. Socket 28 is in frictional engagement with power plug 35 when the present power supply system is in use.

A battery pack charger at 38 in FIG. 5 includes a power supply cord 39 equipped with a plug (not shown) for plugging into a 125 v. A.C., outlet.

While I have shown but a few embodiments of the invention, it will be apparent to those skilled in the art that the invention may be embodied still otherwise without departing from the spirit and scope of the claimed invention.

Having thus described the invention, what is desired to be secured by a Letters Patent is:

1. An electrical supply system for a hand-held electric tool having a receptacle with electrical contacts, the system comprising,
a battery pack including attachment means for supported engagement with a support remote from the hand-held electric tool,
an electrical cord several feet in length served by said battery pack, and
an electrical connector having a pair of contacts in circuit with said battery pack via said cord, for engagement with the electrical contacts on the hand held electric tool.

2. An electrical supply system for a cordless electric hand held tool, the system comprising,
an electrical connector having a connector plug having electrical contacts for inserted engagement with the electric hand tool and with internal contacts in said tool,
a battery pack,
an electrical cord several feet in length in circuit with said battery pack and with said connector plug electrical contacts, and
support means for confining said battery pack in place on a support.

3. The electrical supply system claimed in claim 2 wherein said support means is a clip on said battery pack for supported engagement with a workman's attire.

4. The electrical supply system claimed in claim 2 wherein said electrical connector includes latches for engagement with the electric hand-held tool.

5. The electrical supply system claimed in claim 1 wherein said battery pack includes a power plug with said pair of electrical contacts on said power plug.

6. The electrical supply system claimed in claim 5 wherein said electrical cord includes a socket for detachable engagement with said power plug.

7. The electrical supply system claimed in claim 2 wherein said electrical cord includes a socket for detachable engagement with said battery pack.
